(19) United States
(12) Patent Application Publication
(10) Pub. No.: US 2012/0281695 A1
(43) Pub. Date: Nov. 8, 2012

(54) CONTROL PACKET BICASTING BETWEEN STACKABLE DEVICES

(75) Inventor: Bipin Agarwal, San Jose, CA (US)

(73) Assignee: BROCADE COMMUNICATIONS SYSTEMS, INC., San Jose, CA (US)

(21) Appl. No.: 13/464,925

(22) Filed: May 4, 2012

Related U.S. Application Data
(60) Provisional application No. 61/483,037, filed on May 5, 2011.

(51) Int. Cl. H04L 12/56

(52) U.S. Cl. 370/389

(57) ABSTRACT

Techniques that enable a network device such as a switch to bicast control packets to an active controller and a standby controller in a stackable system. Techniques are provided for encapsulating control packets with one or more proprietary headers to bicast encapsulated control packets to an active controller and a standby controller in a stackable system.

### CROSS-REFERENCES TO RELATED APPLICATIONS

The present application claims the benefit and priority under 35 U.S.C. 119(e) of U.S. Provisional Application No. 61/483,037, filed May 5, 2011 and entitled “Control Packet Bi-cast between stackable devices,” the entire contents of which are incorporated herein by reference for all purposes.

### BACKGROUND

A system of connecting a plurality of network switches (stackable devices) into a single management unit is a stackable system (stack). A stackable device typically includes two dedicated stacking ports, which are used to connect other stackable devices in a stack. In a stack, the stackable devices may be connected in various topologies. By default, one of connected stackable devices becomes an active controller (active), which handles stack management and configures stack features. In order to achieve active controller redundancy, one of stackable devices in a stack becomes a standby controller (standby). A conventional stack is configured to forward a control packet received from a network to an active controller, but not to a standby controller. It would therefore be desirable to have a manner of configuring a stackable system, which overcomes this deficiency.

### BRIEF SUMMARY

Embodiments of the present invention provide techniques that enable a network device such as a switch to bicast control packets to an active controller and a standby controller.

In one embodiment, a stackable system may comprise an active controller, a standby controller, and a stack member. The active controller controls stack management and configures features in a stackable system. The standby controller does not perform the functions performed by the active controller. The standby controller takes over the functions of the active controller if the active controller fails. The stackable system may receive a control packet at a stack member. The control packet is encapsulated with a proprietary header, then bicasted to the active controller and standby controller.

In one embodiment, a control packet is a layer 2 and layer 3 protocol packet used to build a database to handle data packets received from a network.

In one embodiment, when an active controller receives a control packet, the active controller encapsulates the control packet with a proprietary header, then forwards the encapsulated control packet to standby controller, but not to any stack member.

In one embodiment, when standby controller receives a control packet, the standby controller encapsulates the control packet with a proprietary header, then forwards the encapsulated control packet to active 110A, but not to any stack member.

The foregoing, together with other features, aspects, and advantages of the embodiments of present invention, will become more apparent when referring to the following description, and accompanying drawings.

### BRIEF DESCRIPTION OF THE DRAWINGS

FIG. 1 is a block diagram of a stack that includes three stackable devices, which are configured in a linear topology in accordance with one embodiment of the present invention.

FIG. 2 is a block diagram illustrating encapsulation and decapsulation of a control packet as performed by a stack.

### DETAILED DESCRIPTION

In the following description, for the purposes of explanation, specific details are set forth in order to provide a thorough understanding of various embodiments. It will be apparent, however, that the invention may be practiced without these specific details.

Embodiments of the present invention provide various techniques that enable a stackable device such as a switch to bicast control packets to an active controller and a standby controller.

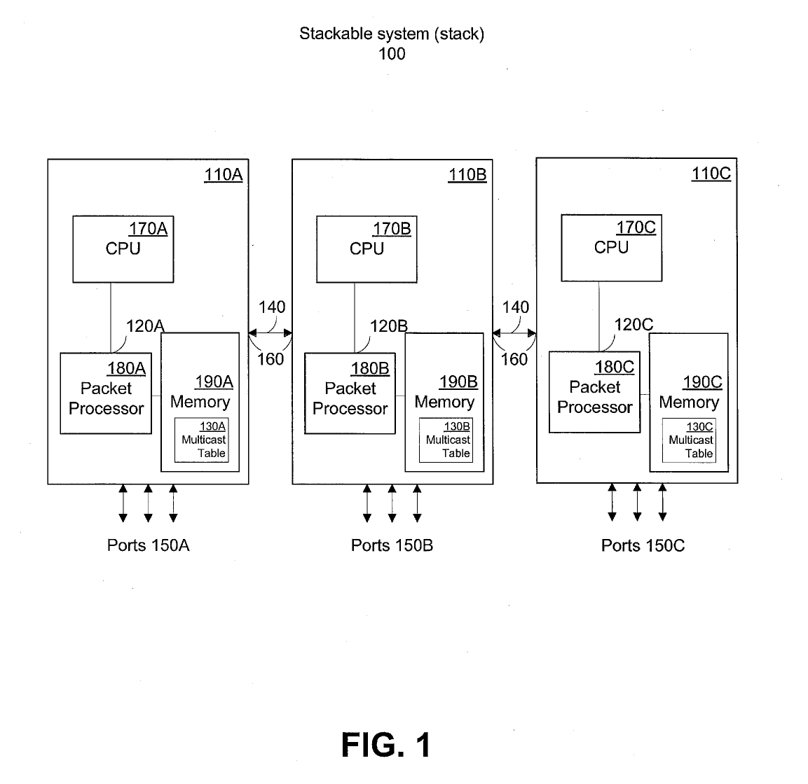

FIG. 1 is a block diagram of a stackable system (stack) 100 that may incorporate an embodiment of the present invention. As shown, a stack 100 comprises multiple stackable devices 110A, 110B, and 110C communicatively coupled to each other via stacking links (cables) 140. Stackable devices 110 shown in FIG. 1 are configured in a linear topology. In some embodiments, stackable devices may be connected in a ring topology. Stackable devices 110 are configured to forward data so as to facilitate communication of data from a sender to one or more receivers in a network. Examples of such stackable devices 110 include but are not limited to switches, routers, and the like. One or more stackable devices in stack 100 may be configured to perform control packet forwarding. For example, a stackable device 110C may be configured to receive a control packet, and then bicast the control packet to stackable devices 110A and 110B. Stackable devices 110 may be switches provided by Brocade Communications Systems, Inc.

Stackable devices 110 are configured to receive packets, including control packets, and forward the control packets in such a way that it facilitates delivery of the control packets to their intended one or multiple destinations. For a control packet, stackable devices 110 may be configured to replicate the control packet depending upon the number of recipients of the control packet and forward the replicates to their intended recipients.

A simplified block diagram of each stackable device 110 is depicted in FIG. 1. As shown, each stackable device 110A, 110B, and 110C comprises a plurality of ports 150 and stacking ports 160 for receiving and forwarding data packets.

The components of stack 100 and stackable devices 110 depicted in FIG. 1 are meant for illustrative purposes only and are not intended to limit the scope of the invention in any manner. Alternative embodiments may have more or fewer components that that shown in FIG. 1. For example, in one embodiment, stack 100 may include up to eight stackable devices. In yet other embodiments, stack 100 may be limited to another number of stackable devices.

A port within ports 150 and stacking ports 160 may be classified as an input port or an output port. A particular port may function both as an input port and an output port. Ports 150 and stacking ports 160 may be capable of receiving or transmitting different types of data traffic.

Each stackable device 110 comprises a CPU 170, which may be a general purpose microprocessor. Each CPU 170 can execute software codes or programs for controlling the operations of stackable devices 110.

As shown in FIG. 1, stackable devices 110 also comprises one or more packet processors 180 that are programmed to perform processing related to packets forwarding from an input port to an output port. Each packet processor 180 is a dedicated hardware device configured to perform the processing. In one embodiment, packet processor 180 is an application specific integrated circuit (ASIC). Packet processor 180 and CPU 170 in each stackable device 110 are communicatively coupled. Packet processor 180 may have associated memories 190 to facilitate packet forwarding. In one embodiment, as shown in FIG. 1, each packet processor 180 has an associated memory 190 for performing lookups. In another embodiment, packet processor 180 is configured to extract information from a packet received by stackable device 110, and performs one or more lookups in associated memory 190. The extracted information may include the header of the received packet or other portions of the received packet.

In one embodiment, CPU 170 is configured to form a multicast hardware index, where the index indicates the one or more ports to which a packet is to be forwarded. The multicast hardware index identifies a set of one or more ports in a table. The table may be a multicast index table 130. In one embodiment, a multicast hardware index is used to index into a multicast index table 130 and the indexed entry shows which ports are the output interfaces for the packet.

The multicast hardware index thus is used to determine one or more output ports to be used for forwarding a packet. For a multicast packet, there may be multiple output ports on different stackable devices. For example, ports 150, stacking ports 160, and CPU ports 120 may be the ports shown in the table.

In one embodiment, stackable device 110A operates as an active controller (active), stackable device 110B operates as a standby controller (standby), and stackable device 110C operates as a stack member in stack 100. Active 110A controls stack management and configures features in stack 100. Standby 110B does not perform the functions performed by active 110A. Standby 110B takes over the functions of active 110A if active 110A fails.

One or more proprietary headers may be used to facilitate control packet forwarding within a stackable device or between stackable devices. A proprietary incoming header may be used for control packets that are intended to go to CPU 170 for further processing. A proprietary outgoing header may be used for control packets that are coming from CPU 170. A proprietary bypass header may be used for control packets that are intended to go to an active controller and a standby controller in a stackable system. In one embodiment, a proprietary header may be a Distributed Switch Architecture (DSA) header by Marvell Technology Group Ltd or a Brocade proprietary header.

When a control packet is received by stack member 110C via port 150C, the received control packet is encapsulated with a proprietary incoming header . The proprietary incoming header may includes incoming port information, incoming device information, or type of the received packet information. The control packet encapsulated with the proprietary incoming header is then passed to CPU 170C via packet processor 180C for further processing. Since the control packet is not received by its indented destinations, active 110A or standby 110B, the control packet encapsulated with the proprietary incoming header is encapsulated with a proprietary bypass header by CPU 170C.

The control packet is encapsulated with a proprietary incoming header which in turn is encapsulated with a proprietary bypass header which comprises a multicast hardware index. The multicast hardware index is then used to determine one or more output ports. In one embodiment, stacking port 160, CPU port 120A, and CPU port 120B are output ports determined by the multicast hardware index from the multicast index table.

The encapsulated control packet is thus replicated and then bicasted to both CPU 170A in active 110A and CPU 170B in standby 110B for further processing. CPU 170A and CPU 170B strip the proprietary bypass header from the encapsulated control packet, and then the remaining proprietary incoming header is processed by CPU 170A and CPU 170B. The information in the proprietary incoming header is used to update state information or build a database to handle received data packets.

In one embodiment, control packets received by stack 100 are sent to both active 110A and standby 110B by using bicasting. The sending of a control packet to both active 110A and standby 110B is referred to as bicasting. According, bicasting is a mechanism that delivers control packets to both active controller and standby controller, so that both can populate the same information based upon the control packets.

In one embodiment, when active 110A receives a control packet, the active 110A encapsulates the control packet with a proprietary outgoing header, then forwards the encapsulated control packet to standby 110B, but not to any stack member.

In one embodiment, when standby 110B receives a control packet, the standby 110B encapsulates the control packet with a proprietary outgoing header, then forwards the encapsulated control packet to active 110A, but not to any stack member.

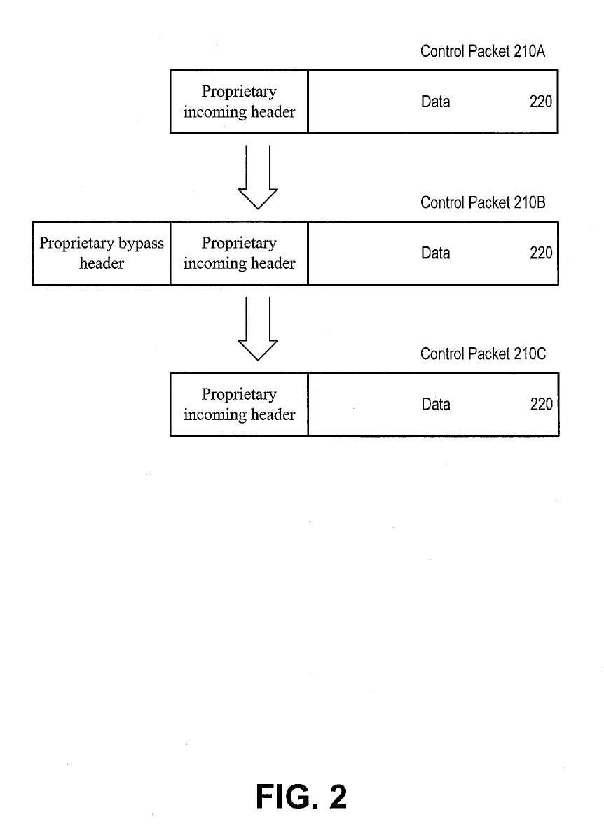

FIG. 2 illustrates encapsulation and decapsulation as performed by stack 100 of FIG. 1. An incoming control packet 210A contains data 220 which is encapsulated with a proprietary incoming header.

In one embodiment, CPU 170C encapsulate the incoming control packet 210A with a proprietary bypass header. The incoming control packet now appears at 210B. After bicasting the control packet shown at 210B to both active 110A and standby 110B, CPU 170A and 170B strip off the proprietary bypass header as shown in 210C to obtain information in the proprietary incoming header.

In one embodiment, encapsulation and decapsulation steps for the control packet are done at a driver layer instead of an application layer.

While the present invention has been described with respect to a limited number of embodiments, practitioners will appreciate numerous modifications and variations therefrom. For instance, while the various embodiments described above have been described in the context of network devices, the teaching herein may be applied in different domain other than networking, such as general purpose computing. It is intended the appended claims cover all such modification and variations as fall within the true spirit and scope of this present invention.

What is claimed is:

1. A network switch stack comprising:
an active controller;
a standby controller; and
a stack member,
wherein said active controller, said standby controller, and said stack member are configurable to be part of a network switch stack,
wherein at least one of said active controller and said standby controller receives a control packet including two internal switching headers.

2. The network switch stack of claim 1, wherein said internal switching header is a Distributed Switch Architecture (DSA) header.

3. The network switch stack of claim 1, said stack member encapsulates said internal switching header in said control packet.

4. The network switch stack of claim 1, said active controller encapsulates said internal switching header in said control packet.

5. The network switch stack of claim 1, said standby controller encapsulates said internal switching header in said control packet.

6. The network switch stack of claim 1, wherein said internal switching header comprises packet forwarding information.

7. The network switch stack of claim 1, wherein said stack member encapsulates said internal switching header in a control packet at a device driver layer.

8. The network switch stack of claim 1, wherein said active controller encapsulates said internal switching header in a control packet at a device driver layer.

9. The network switch stack of claim 1, wherein said standby controller encapsulates said internal switching header in a control packet at a device driver layer.
